(19) United States
(12) Patent Application Publication
(10) Pub. No.: US 2016/0204839 A1
(43) Pub. Date: Jul. 14, 2016

(54) Multi-band Antenna for Wearable Glasses

(71) Applicant: Futurewei Technologies, Inc., Plano, TX (US)

(72) Inventors: Hongwei Liu, San Diego, CA (US); Wee Kian Toh, San Diego, CA (US); Ping Shi, San Diego, CA (US)

(21) Appl. No.: 14/594,941

(22) Filed: Jan. 12, 2015

(51) Int. Cl. H04B 7/04; G02B 27/01; H04W 4/00; H04B 1/40; H04W 4/02

(52) U.S. Cl. CPC H04B 7/04; H04B 1/40; H04W 4/02; H04W 4/008; G02B 27/017; H04W 84/12

(57) ABSTRACT

An embodiment eyeglass display includes a processor disposed in a system enclosure and a display system connected to the processor and configured to display data to a user via a display screen in an eye region. A first antenna is disposed in the system enclosure and operably connected to the processor. The processor is configured to cause the first antenna to transmit on a first radio frequency (RF) band. A second antenna is disposed outside the system enclosure and operably connected to the processor, and the processor is configured to cause the second antenna to transmit on a second RF band. The second antenna extends laterally along a first edge of the at least one eye region.

### TECHNICAL FIELD

The present invention relates generally to systems and methods for wearable eyeglass displays, and, in particular embodiments, to systems and methods for providing multiple wireless communications antennas with improved antenna isolation.

### BACKGROUND

Industrial design of modern wireless devices is evolving towards lower profile devices, and integrating those devices into nontraditional communications devices. These modern wireless devices include cellular phones and tablets, while nontraditional communications devices may be wearables such as watches, eyeglasses and virtual reality headsets or the like. Wireless devices require multiple multi-band radio frequency (RF) antennas to operate on, or near, users. Typical antennas include main cellular antennas, diversity antennas, wireless networking (e.g., WiFi, 802.11, Bluetooth) antennas, near field antennas (e.g., NFC, wireless charging) and global positioning (e.g., GPS) antennas. Multiple multi-band antennas should be co-designed to cooperate with each other and with other electromagnetic components such as speakers, LCD screens, batteries, sensors, etc. However, antennas in proximity to each other result in low isolation, reduced efficiency and increased channel interference. In some devices, separate antennas are used for communicating on WiFi and cellular RF bands. Additionally, some cellular antenna systems include multiple antennas that communicate on the same bands or frequencies, with active antenna switches changing between the antennas when one of antennas is obstructed by the user, for example, by the user's hand position on the device. The performance of the cellular antenna becomes increasingly important as it is frequently located next to other antennas such as WiFi & GPS combination antennas. The proximity of the cellular antennas becomes increasingly critical as the size of devices is shrunk, since the increasingly smaller devices afford less room for the antennas.

### SUMMARY

An embodiment eyeglass display includes a processor disposed in a system enclosure and a display system connected to the processor and configured to display data to a user via a display screen and/or projector in an eye region. A first antenna is disposed in the system enclosure and operably connected to the processor. The processor is configured to cause the first antenna to transmit on a first radio frequency (RF) band. A second antenna is disposed outside the system enclosure and operably connected to the processor, and the processor is configured to cause the second antenna to transmit on a second RF band. The second antenna extends laterally along a first edge of the at least one eye region.

An embodiment eyeglass display device includes a system enclosure disposed on an earpiece and a processor disposed in the system enclosure. A display screen and/or projector is disposed in at least one of a plurality of eye regions, and the processor is configured to display data to a user via at the display screen and/or projector. A cellular transceiver is connected to the processor and a first cellular antenna is disposed outside the system enclosure and is operably connected to the cellular transceiver. The cellular transceiver is configured to transmit on one or more cellular bands through the first cellular antenna. The first cellular antenna extends laterally along a first edge of at least one of the plurality of eye regions.

An embodiment method includes providing a user interface by an eyeglass display device and on a display screen disposed in an eye region of the eyeglass display device. The eyeglass display device has a processor and a first antenna disposed in a system enclosure, with a second antenna disposed outside of the system enclosure and extending over the eye region. The first antenna is configured to communicate in a first radio frequency (RF) band, and the second antenna is configured to communicate in a second RF band. The method further includes performing at least part of a first communication using the first antenna in response to first commands from the processor and performing at least part of a second communication using the second antenna in response to second commands from the processor.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram illustrating components of an eyeglass display according to some embodiments;

FIG. 2 is a diagram illustrating the eyeglass display 100 according to some embodiments;

FIGS. 3A through 3C are cross-sectional diagrams illustrating various arrangements of cellular antennas in upper eyewires and a bridge of the eyeglass display 100 according to some embodiments;

FIGS. 4A through 4B are cross-sectional diagrams illustrating various arrangements of cellular antennas in the upper eyewires, bridge and lower eyewires of the eyeglass display according to some embodiments; and

FIGS. 5A through 5E are cross-sectional diagrams illustrating various arrangements of cellular antennas in the eyeglass display according to some embodiments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. Additionally, the methods and apparatuses described may be applied to wireless communications system antenna layout and design, but are not specifically limited to the same.

Modern communications devices provide the ability to communicate on multiple distinct channels in different frequency bands simultaneously, providing increased data throughput and multiple simultaneous wireless communications services in a single device. Many wireless communications devices are designed to be multi-band devices, with the ability to communicate on different cellular frequency bands, such as the 700 MHz-900 MHz bands, 1700 MHz, 1900 MHZ, 2100 MHz and 2500 MHz bands. Additionally, wireless devices frequently have additional features such as WiFi connectivity on, for example, the 2.4 GHz, 3.6 GHz, 5 GHz bands, or the like, and GPS on the 1227 MHz and 1575 MHz frequencies. The ability to communicate on different frequencies or bands can be provided by multi-band antennas. For example, in some devices, cellular service is provided by an antenna or set of antennas that is configured to communicate on two or more of the different cellular frequency bands, and supplemental services are provided by a WiFi/GPS antenna that is configured to communicate on the WiFi and GPS bands.

However, in some instances, the cellular bands and the WiFi or GPS bands may overlap, causing interference when the cellular and GPS/WiFi antennas are in close proximity. Additionally, in relatively small devices, and particularly, in wearable communications devices such as watches, eyeglasses and virtual reality headsets, the antennas for similar frequency bands are allocated increasingly smaller space. For example, cellular antennas optimized for the 824-960 MHz and 1700-2700 MHz ranges require large volume to work efficiently. Such frequencies are close to, or overlap, the GPS and WiFi signals. The overlapping bands, combined with the proximity of the cellular antennas and GPS/WiFi antennas causes interference in the antennas. For example, transmission on a cellular antenna in the 1700 MHz band may cause interference with GPS signals in the 1575 MHz frequency band. Interference with such a signal is particularly problematic since the GPS signals are transmitted from satellites, resulting in weak and easily overpowered signals.

In many wearable devices, the electronics, including antennas for various communications services, are bundled into a singular systems module. The proximity of a user's body to the systems module that is inherent in a wearable device may result in the user's body absorbing or blocking parts of the signal transmitted by the antennas. Various systems and methods described herein provide for feeding multiple radiating elements of the antenna in wearable devices such as eyeglass display devices. A GPS/WiFi antenna may be provided within a system enclosure, for example, along the earpiece of the eyeglass display device, and one or more cellular antennas may be provided within the bridge and eyewires surrounding the eyeglass lenses. Routing the portions of the GPS/WiFi antenna on a different side of the wireless device from the cellular antenna improves the antenna efficiency and isolation of antennas that share the same or overlapping frequency bands. The cellular antenna may be provided with a feed point at various points in the eyeglass frames, permitting tuning of the radiation aperture for the cellular antennas. Additionally, multiple antennas and multi-band antennas may also be provided by tuning the distances that the cellular antennas extend around the eyeglass lenses.

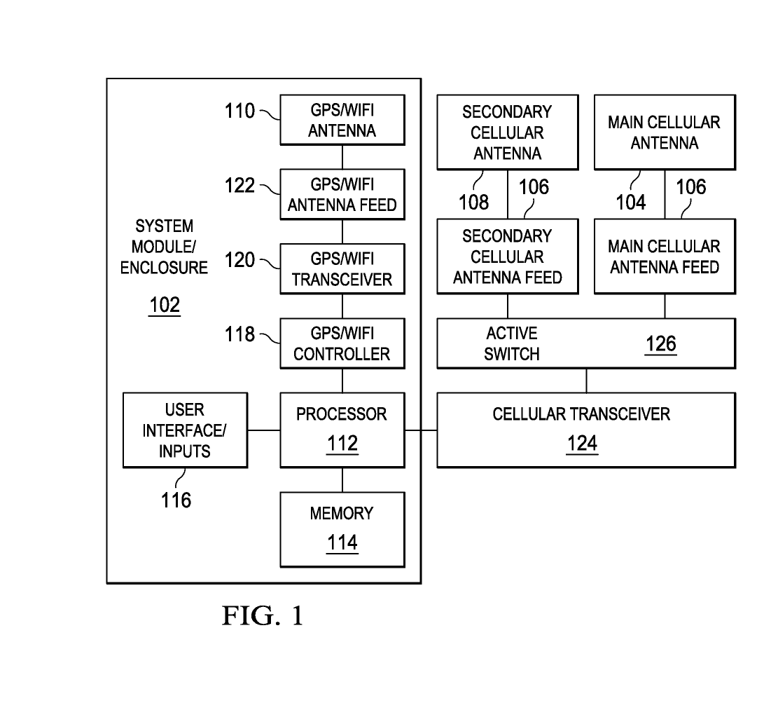

FIG. 1 is a block diagram illustrating components of an eyeglass display 100 according to some embodiments. The eyeglass display 100 comprises a processor 112, a memory 114, a user interface/user input 116 and a secondary interface such as a GPS/WiFi transceiver 120. These components of the eyeglass display 100 may form a system module or be disposed in a system enclosure 102 that is a housing, casing, enclosure or the like, that is, in various embodiments, conductive or non-conductive. The processor 112 may be any component capable of performing computations and/or other processing related tasks, and the memory 114 may be any component capable of storing programming and/or instructions for the processor 112. The user interface/inputs 116 that are connected to the processor 112 to permit a user to execute or interact with one or more programs or communications services running on the processor 112.

The eyeglass display 100 is configured to communicate over a cellular band, and over one or more secondary bands. The eyeglass display 100 has a cellular interface such as a cellular transceiver 124. The processor 112 in the system enclosure 102 is configured to transmit or receive signals through the main cellular antenna 104 or secondary cellular antenna 108 and cellular transceiver 124. In some embodiments, the cellular transceiver 124 is disposed outside of the system enclosure 102, and in other embodiments, the cellular transceiver 124 is housed within the system enclosure 102. The cellular transceiver 124 is connected to the main cellular antenna 104 by way of a first feed point 106, and in some embodiments, the cellular transceiver 124 is also connected to a second cellular antenna 108 by a second feed point 106. A switch 126 may be disposed between the cellular transceiver 124 and the cellular antennas 104, 108, and may be configured to switch the communication of the cellular transceiver 124 between the antennas 104, 108 based on a command from the processor or cellular transceiver 124. The cellular transceiver 124 may be any component or collection of components that allows the eyeglass display 100 to communicate using a cellular signal, and may be used to receive and/or transmit information over a cellular connection with a cellular network. In some embodiments, the cellular transceiver 124 may be formed as a single device, or alternatively, a separate receiver and transmitter.

The eyeglass display 100 further has a secondary interface such as a GPS/WiFi transceiver 120, with the GPS/WiFi transceiver 120 in electrical communication with a GPS/WiFi controller 118. The GPS/WiFi controller 118 and GPS/WiFi transceiver 120 may, in some embodiments, be a device such as a system-on-chip, add-on board or discrete component disposed in the system enclosure 102. In other embodiments, the GPS/WiFi controller 118 and GPS/WiFi transceiver 120 are integrated into a circuit board of the system enclosure 102, and in some embodiments, the processor 112 may execute portions of the GPS/WiFi communication management. In other embodiments, the secondary interface may be any component or collection of components that allows the device to communicate data or control information via a supplemental protocol. For instance, the secondary interface may be a non-cellular wireless interface for communicating in accordance with a Bluetooth, near field communication, wireless charging, or other wireless protocol.

The system enclosure 102 further has disposed therein one or more secondary antennas for providing communication capabilities for communications services using the secondary interface such as Bluetooth, GPS, WiFi, or the like. In some embodiments, the secondary antenna is a dual mode antenna configured to communicate, transmit and/or receive on multiple bands for multiple communications services. For example, the secondary antenna may be a GPS/WiFi antenna 110 that communicates or receives GPS positioning signals on a GPS frequency, set of frequencies or frequency band. Such a GPS/WiFi antenna may also be configured to transmit and receive WiFi signals on, for example, 2.4 GHz, 3.6 GHz or 5 GHz WiFi bands. The GPS/WiFi transceiver 120 may further be in signal communication with a GPS/WiFi antenna 110 through the GPS/WiFi antenna feed 122. The processor 112 is configured to transmit or receive signals through the GPS/WiFi antenna 110, GPS/WiFi controller 118 and GPS/WiFi transceiver 120.

A user may access the wireless communications services on the eyeglass display 100 and initiate a first communication by way of a first communication service that uses a first band. For example, initiating a telephone call, data request, or the like, may cause the eyeglass display 100 to transmit data over a cellular network using the cellular transceiver 124. Such a request causes the eyeglass display 100 to communicate on a first antenna such as the main cellular antenna 104 or secondary cellular antenna 108. A user may also initiate a second communication by way of a second communication service, such as WiFi or GPS. For example, a user may request a GPS location, which causes the processor 112 to receive a GPS location signal through the GPS/WiFi antenna 110 in response to the user action. The second communication uses a second band and causes the eyeglass display 100 to communicate on the second band using a second antenna. Additionally, a request using the first communication service may take place at the same time as using the second communication service. For example, a user may request a map over a cellular network, and also request that the system display the user's location on the map. Therefore, the user initiates the first communication for the map over the cellular network and initiates the second communication on the GPS band for receiving the GPS signal to determine the user's position for display on the map. In another example, a user may connect to a cellular network through the cellular transceiver 124 to engage in a telephone call, and may simultaneously connect to a WiFi network through the GPS/WiFi antenna 110 for data retrieval, web browsing, media access, or the like.

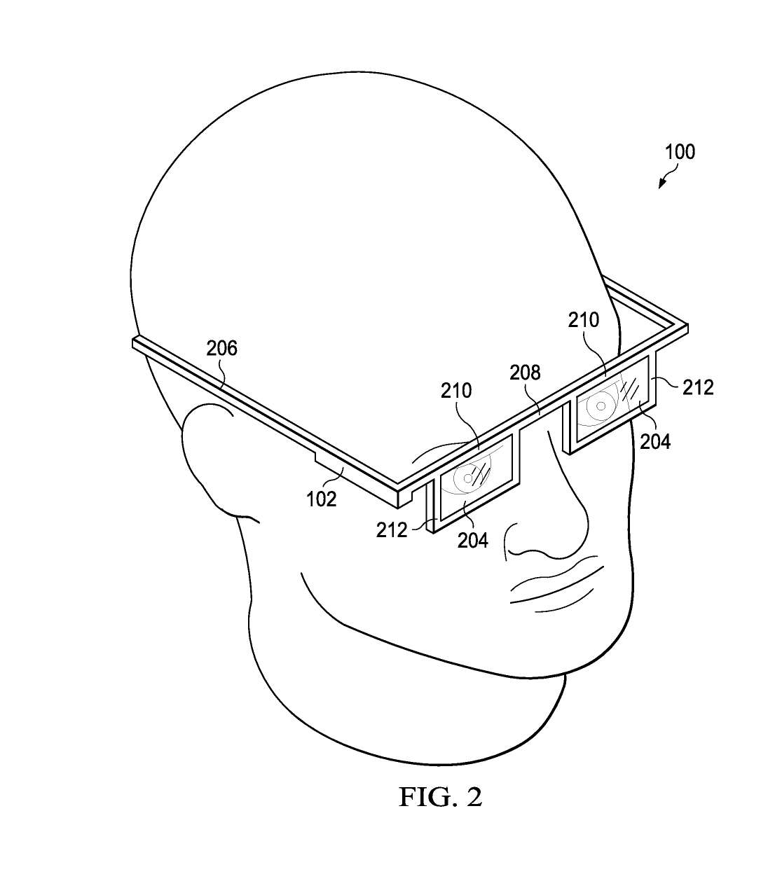

FIG. 2 is a diagram illustrating an eyeglass display 100 according to some embodiments. The eyeglass display 100 has earpieces 206 that extend along the side of a user's head, and retain the eyeglass display 100 by hooking over the ears of the user. The earpieces 206 are joined by upper eyewires 210 and a bridge 208 spanning the user's nose and separating the upper eyewires 210. In various embodiments, the earpieces 206 are conductive or non-conductive.

In some embodiments, the lenses 204 are retained against the upper eyewires 210 by lower eyewires 212, and in other embodiments, the lower eyewires 212 are omitted.

One or both of the earpieces 206 have a system enclosure 102 mounted thereon. In some embodiments, part of the user interface/input 116 in the system enclosure 102 has a display system that displays data to a user via a display surface disposed in an eye region. Thus, the eyeglass display 100 uses eyeglass frame that extends across the bridge of a user's nose to hold a display screen in in front a user's eye.

In some embodiments, the eyeglass display 100 has lenses 204 disposed in eye regions so that a user may use the lenses 204 as they would standard eyeglasses. The display screen may be such as a discrete display screen, or the lenses 204 may be used as a display screen. In some embodiments, the display system controls a transparent screen such as a liquid crystal display (LCD), light emitting diode (LED) display, or the like. In other embodiments, the display system has a projector that projects light into the interior surface of a display screen for viewing. In different embodiments, the display screen may be lenses 204, or may be a separate screen. For example, a display surface may be embedded in the lenses, formed on the surface of the lenses 204. Alternatively, in an embodiment where the display system uses a projector, the display system may project a data display to a user on the interior surface of the lenses 204. In other examples, a display screen separate from any lenses 204 is located in an eye region, and is used as a screen for a projector, or as an active display screen such as an LCD or LED screen. The separate display screen may, in some embodiment, eliminate the need for lenses. Thus, the eyeglass display 100 may be eyeglass frames with a display screen held in an eye region and the necessary components for providing the user interface and communications capabilities.

The user interface/input 116 also comprises, in some embodiments, a voice activated control system, but may also have a touch interface, gesture recognition interface, or a wireless interface such as a Bluetooth keyboard, mouse, joystick, gamepad, or the like.

The cellular transceiver 124 connects to, and communicates using, one or more cellular antennas 104, 108 that are disposed in one or both of the upper eyewires 210, and that are described in greater detail, below. Additionally, the cellular antennas 104, 108 may extend in the lower eyewires 212 around the lenses 204, providing a greater area for antenna layout and multiple paths for multiple conductive elements, permitting optimization of the antennas for multiple frequency bands.

In some embodiments, the GPS/WiFi antenna 110 (FIG. 1) is disposed within the system enclosure 102 along the earpiece 206. The earpiece 206 holds the GPS/WiFi antenna 110 apart from a user's head, reducing the specific absorption rate (SAR) and the amount of energy absorbed by the user's body.

Providing the cellular antennas 104, 108 in the upper and lower eyewires 210, 212 and providing the GPS/WiFi antenna 110 disposed on or along the earpieces 206 increases the separation between the GPS/WiFi antenna 110 and cellular antennas 104, 108 without increasing the volume required to enclose or support the antennas 104, 108, 110. The increased separation between the antennas 104, 108, 110 reduces the interference between antennas 104, 108, 110 by increasing the isolation of the radio frequency signals transmitted and received by the antennas 104, 108, 110. Additionally, the absorption of the RF signals by the user's body reduces the amount of radiation transmitted directly between the antennas, further increasing antenna isolation and reducing interference between antennas 104, 108, 110 transmitting on bands with overlapping or adjacent frequencies.

Thus, the eyeglass display 100 allows a user to access one or more communications services that communicate on the GPS/WiFi antenna 110 and one or more of the cellular antennas 104, 108 simultaneously with reduced interference and increase transmission efficiency. For example, the eyeglass display 100 may initiate or perform a first communication in response to a user command through the user interface and by way of a first communication service that uses a first antenna on a first RF band, such as the GPS/WiFi antenna 110. The eyeglass display 100 may also initiate or perform a second communication by way a second antenna on a second RF band such as one of the cellular antennas 104, 108. In such an example, the first and second communication may be completely, or partially simultaneous. Additionally, the first and/or second communication is not limited to being initiated by a user command, as either or both of the first and second communication may be initiated by the eyeglass display 100 automatically or without user intervention.

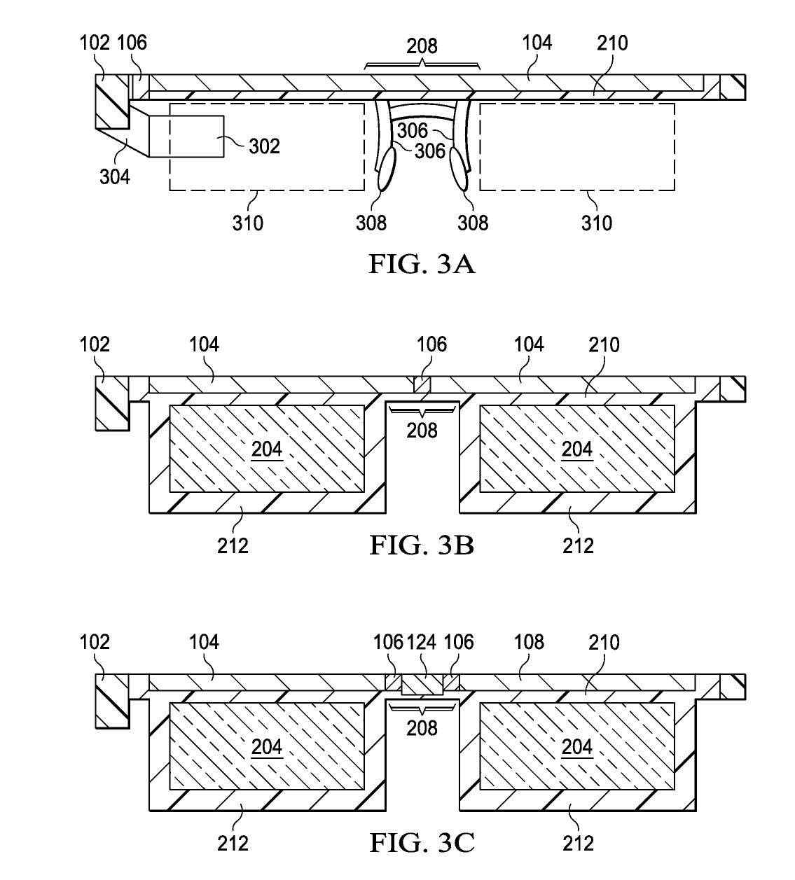

FIGS. 3A through 3C are cross-sectional diagrams illustrating various arrangements of cellular antennas 104, 108 in the upper eyewires 210 and bridge 208 of the eyeglass display 100 according to some embodiments. One or more antenna portions may be disposed in the frames of the eyeglass display 100, and may be connected to the cellular transceiver 124 by one or more feed points 106 that are disposed in various places in the eyeglass display 100 frames.

FIG. 3A is a cross-sectional diagram illustrating a cellular antenna 104 in the upper eyewires 210 and bridge 208 of the eyeglass display 100 according to some embodiments. Additionally, the embodiment shown in FIG. 3A illustrates an eyeglass display frame without lenses. In such an embodiment, a display screen 302 is held, by a display support 304, in an eye region 310 of the eyeglass display. Nosepiece supports 306 and nosepads 308 replace the lower eyewire 212 and allow positioning of the eyeglass display 100 on a user's face. In an embodiment where the display screen 302 is an active display, the display screen may be electrically connected to the components in the system enclosure 102 so that the processor in the system module can display data to the user on the display screen. In an embodiment where a projector is used to display data on the display screen, the display screen 302 needs no electrical connection to the system module.

A feed point 106 is disposed at an end of, for example, the main cellular antenna 104. The main cellular antenna 104 is disposed within, or forms a part of, the frame of the eyeglass display 100 as discussed in greater detail below. The main cellular antenna 104, in an embodiment, extends from the feed point 106 at a temple, corner or hinge region of the eyeglass display 100 through a first upper eyewire 210, over a first eye region, through the bridge 208, and through a second eyewire 210 over a second eye region 310. While not explicitly shown, the eyeglass display frame may have a flexible region, hinge or other adjustment point in the temple area to permit adjustment, removal and increased comfort while a user wears the eyeglass display 100.

The feed point 106 may be connected to the active switch 126 (see FIG. 1) if the eyeglass display 100 has additional cellular antennas, or may be connected directly to the cellular transceiver 124 (see FIG. 1) in embodiments where the eyeglass display 100 has a single cellular antenna or where the cellular transceiver 124 does not switch between multiple cellular antennas. In some embodiments, the cellular transceiver 124 or active switch 126 may be disposed outside of the system enclosure 102, for example, embedded in the frame of the eyeglass display 124, with a wire or other connection connecting the cellular transceiver 124 and/or active switch 126 to components disposed in the system enclosure 102. In other embodiments, the cellular transceiver 124 or active switch 126 are disposed in the system enclosure 102, with a connection extending through the casing of the system enclosure 102 to the feed point 106, electrically connecting the main cellular antenna 104 to components in the system enclosure 102. In such embodiments, the connection from the feed point 106, cellular transceiver 124 or active switch 126 may be connected to the components in the system enclosure by a wire embedded in the eyeglass display frame. In some embodiments where the eyeglass display frame uses a flexible temple region, the connection may run through the temple region. In embodiments where the eyeglass display frame uses a hinge, a conductive hinge may be part of the connection, or a flexible wire connection may be used to bypass the hinge.

While the main cellular antenna 104 is shown in the illustrated embodiment extending completely across both eye regions 310, in other embodiments, the main cellular antenna 104 may extend laterally across just the first eye region 310 to terminate over the first eye region 310 or in the bridge 208 region, or may extend laterally over the first eye region 310, through the bridge 208 region and extend partially over the second eye region 310.

The embodiment shown herein without lenses is not limited to only omitting the lenses. Lenses and/or lower eyewires may be used in such an embodiment, and the separate display screen 302 may be included or omitted without deviating from the teachings of the embodiments.

FIG. 3B is a cross-sectional diagram illustrating a cellular antenna 104 in multiple parts connected to a feed point 106 according to some embodiments. In the illustrated embodiment, the display screen 302 is omitted for clarity and lenses 204 are shown to illustrate the various embodiments. A feed point 106 is disposed, for example, between two portions of the main cellular antenna 104. In such an embodiment, the feed point 106 may be disposed in the bridge 208 region of the eyeglass display 100. In other embodiments, the feed point 106 may be between, and connected to, more than two distinct main antenna 104 portions, or may be disposed in one of the upper eyewires 210 and connected to asymmetrical main antenna 104 portions.

FIG. 3C is a cross-sectional diagram illustrating multiple cellular antennas 104, 108 connected to multiple feed points according to some embodiments. Feed point 106 are each connected to separate antennas, and may, in some embodiments, be connected to a cellular transceiver 124 that is disposed in the frame of eyeglass display 100. Such an arrangement permits separate transmission over the main cellular antenna 104 and secondary cellular antenna 108, and the cellular transceiver 124 may include an active switch 126 (see FIG. 1).

The feed points 106 and cellular transceiver 124 may be disposed in the bridge 208 region of the eyeglass display 100. In other embodiments, one or both of the feed points 106 or the cellular transceiver 124 may be disposed in one of the upper eyewires 210 and the main cellular antenna 104 and secondary cellular antenna 108 may have different shapes. In other embodiments, the cellular transceiver 124 is disposed in the system enclosure 102, and is connected to the feed points 106 through discrete connections, such as, for example, wires separate from the main cellular antenna 104 and secondary cellular antenna 108.

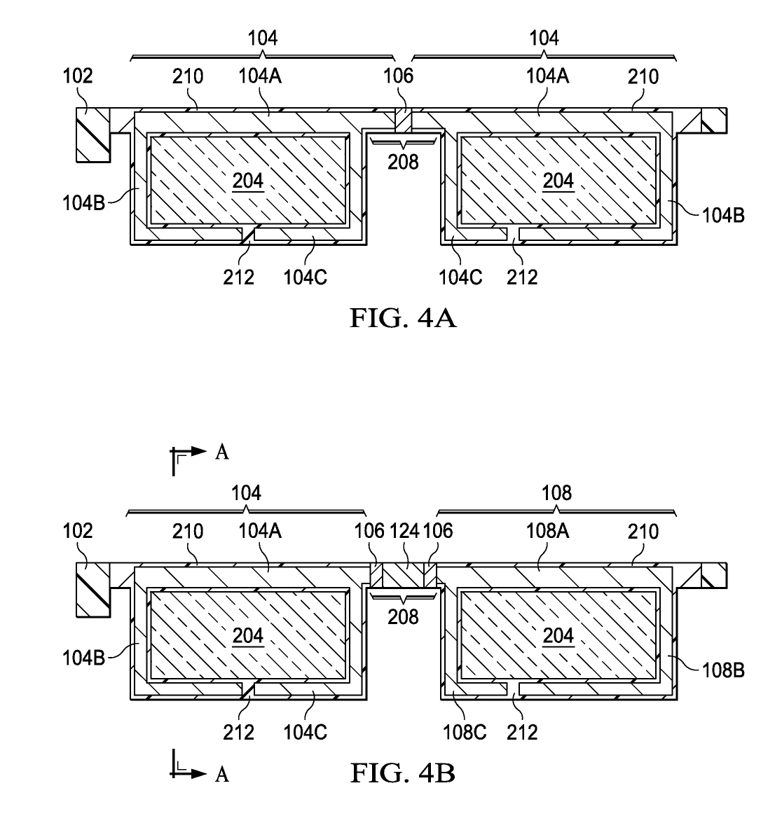

FIGS. 4A through 4B are cross-sectional diagrams illustrating various arrangements of cellular antennas 104, 108 in the upper eyewires 210, bridge 208 and lower eyewires 212 of the eyeglass display 100 according to some embodiments. Each antenna 104, 108 may have one or more antenna portions extending into the lower eyewire 212, and may be connected to the cellular transceiver 124 by one or more feed points 106 that are disposed in various places in the eyeglass display 100 frames.

FIG. 4A is a cross-sectional diagram illustrating a cellular antenna 104 in multiple parts connected to a feed point 106 and with portions of the cellular antenna 104 extending into the lower eyewires 212 according to some embodiments. A feed point 106 is disposed, for example, between two portions of the main cellular antenna 104. In such an embodiment, the feed point 106 may be disposed in the bridge 208 region of the eyeglass display 100. In other embodiments, the feed point 106 may be between, and connected to, more than two distinct main antenna 104 portions, or may be disposed in one of the upper eyewires 210 and connected to asymmetrical main antenna 104 portions.

In the depicted embodiment, each portion of the main cellular antenna 104 has a first antenna portion 104A disposed in the upper eyewire 210 and extending over a respective lens 204. Second antenna portions 104B extend into the lower eyewire portions 212 from respective first antenna portions 104A along first edges of the lenses. In some embodiments, third antenna portions 104C extend into the lower eyewire portions 212 from respective first antenna portions 104A along second edges of the lenses 204 opposite the first edges. In some embodiments, first ends of the second antenna portions 104B and third antenna portions 104C are connected to the respective first antenna portions 104A, while the second the ends of the second antenna portions 104B are spaced apart from the second ends of the respective third antenna portions 104C, forming a discontinuous antenna around the lenses 204. Thus, the separate portions of the cellular main antenna 104 may be tuned for multi-mode operation, having antenna branches with different lengths that will resonate at different radio frequencies or in different RF bands. The embodiments described herein are not limited to having second or third antenna portions 104B, 104C that are symmetrical or the same on each side of the bridge 208. For example, a left portion of the main antenna 104 may have a second or third antenna portion 104B, 104C with a different length or layout than a second or third antenna portion 104B, 104C in the right portion of the main antenna 104.

FIG. 4B is a cross-sectional diagram illustrating multiple cellular antennas 104, 108 that extend into the lower eyewires 212 according to some embodiments. As described above, the cellular transceiver 124 may be disposed in the frame of the eyeglass display 100, for example, in the bridge 208 region. A main cellular antenna 104 and secondary cellular antenna 104 may each connect to individual feed points 106, permitting the cellular transceiver 124 or switch 126 (see FIG. 1) to switch between the cellular antennas 104, 108. The main cellular antenna 104 and secondary cellular antenna 108 each have respective first antenna portions 104A, 108A disposed in separate upper eyewires 210. Additionally, the main cellular antenna 104 and secondary cellular antenna 108 each have respective second antenna portions 104B, 108B and/or third antenna portions 104C, 108C extending into the lower eyewires 212, as described above.

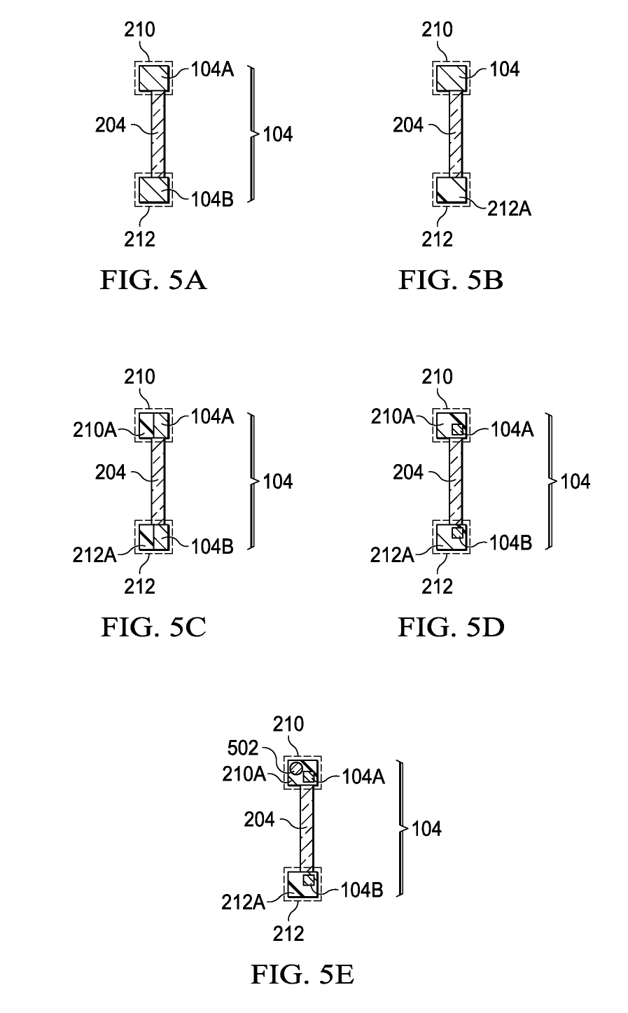

FIGS. 5A through 5E are cross-sectional diagrams of embodiments from FIGS. 3A through 4B, taken along plane AA as shown in FIG. 4B, and illustrating various arrangements of cellular antennas 104 in the eyeglass display 100 according to some embodiments. FIG. 5A is a cross-sectional diagram illustrating the upper and lower eyewires 210, 212 comprising the first and second antenna portions 104A, 104B according to an embodiment. In some embodiments, the material of the eyewires 210, 212 is a conductive material and forms the main cellular antenna 104. Thus, the antenna portions 104A, 104B comprise substantially all of the eyewire 210, 212 cross-sections. In embodiments where one or more of the antennas 104, 108 has a second or third antenna portion 104B, 104C that extends under the lens 204, the lower eyewire 212 forms second or third antenna portion 104B, 104C

In some embodiments, the antenna 104 is formed by casting, molding or machining a metal or other conductive material to form the frame of the eyeglass display 100, including the upper eyewires 210. In some embodiments where the antenna 104 extends into the lower eyewire 212, the lower eyewire 212 may be formed from the same material, and at the same time as the upper eyewire 210, or as a separate piece that is joined or attached to the upper eyewire 210. In some embodiments, a nonconductive coating such as an epoxy, lacquer, enamel, paint, anodized coating, dielectric or the like is applied to the surface of eyewires 210, 212 forming the antenna 104 to electrically insulate the antenna 104 from the surface of the user's skin. Such a nonconductive coating may also be used to house or support the cellular transceiver 124, active switch 126 or hinge region for the earpiece 206 (see FIG. 1) or to fill spaces between the second and third antenna portions 104B, 104C.

FIG. 5B is a cross-sectional diagram illustrating the upper and lower eyewires 210, 212 with the antenna 104 disposed in the upper eyewire 210 according to an embodiment. Such an arrangement is used, for example, in the embodiments shown in FIGS. 3A through 3C, where the main cellular antenna 104 avoids the lower eyewire 212. In such an embodiment, the upper eyewire 210 forms the antenna, as described above. The lower eyewire 212 comprises a lower support portion 212A that is electrically insulated from the antenna 104. In some embodiments, the lower support portion 212A is a polymer such as an epoxy, a plastic or the like that is molded, machined, thermoformed or otherwise formed to hold or accept the lens 204. In an alternative embodiment, the lower support portion 212A/lower eyewire 212 or the lenses 204 is omitted (see, e.g., FIG. 3A), as they is not needed to provide or enclose portions of the antenna 104.

FIG. 5C is a cross-sectional diagram illustrating the upper and lower eyewires 210, 212 with the antenna 104 disposed in the upper and lower eyewires 210, 212 according to an embodiment. In such an embodiment, the antenna 104 may form a portion of the surface of the upper and lower eyewires 210, 212. Upper and lower support portions 210A, 212A are attached to the first and second antenna portions 104A, 104B, respectively. In some embodiments, the upper and lower support portions 210A, 212A may be used to bond the lenses 204 to the antenna 104, and to provide support for hinges or components.

FIG. 5D is a cross-sectional diagram illustrating the upper and lower eyewires 210, 212 with the antenna 104 embedded in the upper and lower eyewires 210, 212 according to an embodiment. In such an embodiment, the antenna 104 is embedded in the upper and/or lower support portions 210A, 212A of the respective upper and lower eyewires 210, 212, with the support portions 210A, 212A forming the surfaces of the eyewires 210, 212. The upper and lower eyewires 210, 212 may be formed by molding or casting the respective support portion 210A, 212A around the antenna 104.

FIG. 5E is a cross-sectional diagram illustrating the upper and lower eyewires 210, 212 with the antenna 104 and additional wiring 502 embedded in the upper eyewire 210 according to an embodiment. In embodiments where a feed point 106, switch 126, or cellular transceiver 124 are disposed in the eyewires 210, 212 remote from the system enclosure 102, it may be necessary to provide signal communication from the system enclosure 102 to the relevant component. Wiring 502 connecting various components may be disposed or embedded in the upper eyewire 210, and be electrically insulated from the antenna 104.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An eyeglass display device comprising:
a processor disposed in a system enclosure;
a display system connected to the processor and configured to display data to a user via a display screen in an eye region;
a first antenna disposed in the system enclosure and operably connected to the processor, and wherein the processor is configured to cause the first antenna to transmit on a first radio frequency (RF) band; and
a second antenna disposed outside the system enclosure and operably connected to the processor, wherein the processor is configured to cause the second antenna to transmit on a second RF band;
wherein the second antenna extends laterally along a first edge of the at least one eye region.

2. The eyeglass display device of claim 1, wherein the first RF band comprises a GPS frequency and one or more wireless networking (WiFi) frequency bands;
wherein the second RF band comprises one or more cellular frequency bands; and
wherein the processor is configured to simultaneously cause the first antenna to transmit on the first RF band and cause the second antenna to transmit on the second RF band.

3. The eyeglass display device of claim 1, wherein the system enclosure is disposed on an earpiece, and wherein the first antenna extends along the earpiece.

4. The eyeglass display device of claim 1, wherein the second antenna is disposed in an upper eyewire and extends over two eye regions.

5. The eyeglass display device of claim 4, wherein the second antenna is connected to the processor by a feed point disposed between the system enclosure and the second antenna.

6. The eyeglass display device of claim 4, wherein the second antenna comprises first antenna portions each connected to the processor of a feed point disposed between the two eye regions, and wherein each of the first antenna portions extend over a respective eye region of the two eye regions.

7. The eyeglass display device of claim 6, further comprising two eyeglass lenses each disposed in a respective one of the two eye regions;
wherein the second antenna further comprises second antenna portions each extending from respective ones of the first antenna portions and along second edges of the two eyeglass lenses.

8. The eyeglass display device of claim 7, wherein each of the second antenna portions has a length different from other ones of the second antenna portions.

9. An eyeglass display device comprising:
a system enclosure disposed on an earpiece;
a processor disposed in the system enclosure;
a display screen disposed in at least one of a plurality of eye regions, wherein the processor is configured to display data to a user via at the display screen;
a cellular transceiver connected to the processor; and
a first cellular antenna disposed outside the system enclosure and operably connected to the cellular transceiver, wherein the cellular transceiver is configured to transmit on one or more cellular bands through the first cellular antenna;
wherein the first cellular antenna extends laterally along a first edge of at least one of the plurality of eye regions.

10. The eyeglass display device of claim 9, further comprising:
a global positioning system/wireless networking (GPS/WiFi) transceiver disposed in the system enclosure; and
a GPS/WiFi antenna disposed in the system enclosure and operably connected to the GPS/WiFi transceiver, wherein the GPS/WiFi transceiver is configured to transmit on one or more WiFi bands through the GPS/WiFi antenna.

11. The eyeglass display device of claim 9, wherein the first cellular antenna is disposed in an upper eyewire and extends from a temple region and away from the system enclosure, over a first one of the plurality of eye regions and over at least a portion of a second one of the plurality of eye regions.

12. The eyeglass display of claim 11, wherein the first cellular antenna is connected to the processor by a feed point disposed between the system enclosure and the first cellular antenna.

13. The eyeglass display device of claim 9, wherein the first cellular antenna comprises first antenna portions each connected to the processor by one or more feed points disposed between two of the plurality of eye regions, and wherein each of the first antenna portions extends over a respective one of the plurality of eye regions.

14. The eyeglass display device of claim 13, further comprising a plurality of eyeglass lenses each disposed in a respective one of the plurality of eye regions;
wherein the first cellular antenna further comprises second antenna portions each extending from respective ones of the first antenna portions and along second edges of the plurality of eyeglass lenses.

15. The eyeglass display device of claim 14, wherein the first cellular antenna further comprises third antenna portions each extending from respective ones of the first antenna portion along third edges of the plurality of eyeglass lenses; and
wherein the third edges of the plurality of eyeglass lenses are opposite the second edges of the plurality of eyeglass lenses.

16. The eyeglass display device of claim 9, further comprising a second cellular antenna extending over a second one of the plurality of eye regions;
wherein the first cellular antenna extends over a first one of the plurality of eye regions;
wherein the cellular transceiver is disposed in a bridge region between the plurality of eye regions;
wherein the second cellular antenna is operably connected to the cellular transceiver; and
wherein the cellular transceiver is configured to transmit over the first and second cellular antennas independently.

17. The eyeglass display device of claim 16, wherein the first cellular antenna comprises a first antenna portion extending over the first lens and a second antenna portion extending from the first antenna portion and along a second edge of the first lens; and
wherein the second cellular antenna comprises a third antenna portion extending over the second lens and a fourth antenna portion extending from the third antenna portion along a second edge of the second lens.

18. A method comprising:
providing a user interface by an eyeglass display device and on a display screen disposed in an eye region of the eyeglass display device, the eyeglass display device having a processor and a first antenna disposed in a system enclosure, the eyeglass display further having a second antenna disposed outside of the system enclosure and extending over the eye region, wherein the first antenna is configured to communicate in a first radio frequency (RF) band, wherein the second antenna is configured to communicate in a second RF band;
performing at least part of a first communication using the first antenna in response to first commands from the processor; and
performing at least part of a second communication using the second antenna in response to second commands from the processor.

19. The method of claim 18, wherein the first RF band is a wireless networking (WiFi) frequency band;
wherein the first communication comprises one of transmitting or receiving a WiFi signal;
wherein the second RF band is a cellular frequency band;
wherein the second communication comprises a cellular communication; and
wherein the first communication and the second communication are performed at least partially simultaneously.

20. The method of claim 19, further comprising generating, by the processor, the first and second commands in response to one or more user inputs through the user interface.
